(19) United States
(12) Patent Application Publication
(10) Pub. No.: US 2010/0215104 A1
(43) Pub. Date: Aug. 26, 2010

(54) Method and System for Motion Estimation

(76) Inventors: Akira Osamoto, Ibaraki (JP); Osamu Koshiba, Ibaraki (JP); Munenori Oizumi, Ibaraki (JP); Tetsu Ohshima, Tokyo (JP); Tomohiro Ezure, Ibaraki (JP); Shigehiko Tsumura, Ibaraki (JP)

Correspondence Address: TEXAS INSTRUMENTS INCORPORATED, P O BOX 655474, M/S 3999, DALLAS, TX, 75265, US

(21) Appl. No.: 12/393,940

(22) Filed: Feb. 26, 2009

(51) Int. Cl. H04N 7/26

(52) U.S. Cl. 375/240.16; 375/E07.123

(57) ABSTRACT

A method of motion vector estimation for video encoding is provided that includes estimating a global motion vector for a sequence of macroblocks in a frame and estimating a motion vector for each macroblock in the sequence of macroblocks using the global motion vector to offset reference data for each macroblock.

### BACKGROUND OF THE INVENTION

Imaging and video capabilities have become the trend in consumer electronics. Digital cameras, digital camcorders, and video cellular phones are common, and many other new gadgets are evolving in the market. Advances in large resolution CCD/CMOS sensors coupled with the availability of low-power digital signal processors (DSPs) has led to the development of digital cameras with both high resolution image and short audio/visual clip capabilities. The high resolution (e.g., sensor with a 2560×1920 pixel array) provides quality offered by traditional film cameras.

More generally, applications for digital video have transcended into the domain of necessary survival equipment for today's digital citizens. In fact, applications involving digital video are so pervasive that virtually all facets of modern life—business, education, entertainment, healthcare, security, and even religion—have been affected by their presence. Aiding in their proliferation, multiple international standards have been created with new ones under development. In the 1990s, low bit-rate applications designed for limited bandwidth video telephony and conferencing motivated early standards like MPEG-1and H.261. These standards provide picture quality comparable to a movie on VHS tape. As more bandwidth became available, MPEG-2, MPEG-4, and H.263 arrived to provide improvements in compression efficiency and DVD movie quality. The latest video coding standards, like WMV9/VC-1 and H.264/MPEG-4 Part 10 (AVC), make use of several advanced video coding tools to provide compression performance that can exceed MPEG-2 by a factor of two but at the expense of much higher complexity.

Common to all of these coding standards is the compression of video in both space and time. However, at closer inspection, even video encoders of the same standard can be very different. In fact, video encoders often use proprietary strategies to improve compression efficiency, which translates directly to better picture quality at a given bit-rate. As video-enabled products continue to be commoditized, picture quality is quickly becoming a distinguishing feature that can foretell success or failure in the marketplace. To build competitive solutions, it is especially imperative that these strategies provide good economy, e.g., better quality for minimal complexity.

Video encoders may include many different tools for reducing both the spatial redundancy of content in each frame and the temporal redundancy between frames. Prediction is the primary technique used for eliminating redundancy. If the prediction is better, the coding efficiency is higher, along with the video quality. Generally in predictive coding, the initial frame in a video sequence is independently compressed similar to a JPEG image using spatial prediction, i.e., intra-prediction, to generate an intra-predicted frame (i.e., an I-frame or I-picture). The subsequent frames are predicted from frames that have already been encoded, i.e., inter-prediction, to generate inter-predicted frames (i.e., P-frames or P-pictures) and/or are predicted from previously encoded frames and future frames to generate bidirectionally-predicted frames (i.e., B-frames or B-pictures). When block-based motion-compensated prediction is used to model change from frame-to-frame, only the differences between the current and predicted frames need to be encoded. This approach has been used in most modern video encoders since the early 1980s.

To track visual differences from frame-to-frame, each frame is tiled into macroblocks. Macroblocks are formed by N×M pixels, where N=M=16 for H.264/AVC. Block-based motion estimation algorithms are used to generate a set of vectors to describe block motion flow between frames, thereby, constructing the motion-compensated prediction. The vectors are determined using block-matching procedures that try to identify the most similar blocks in the current frame with those that have already been encoded in prior frames. Block matching techniques assume that an object in a scene undergoes a displacement in the x- and y-directions between successive frames. This translational displacement defines the components of a two-dimensional motion vector (MV). In general, for each macroblock in a previous frame, also referred to as a reference frame, a window within a new frame is searched for the macroblock that most closely matches the macroblock from the previous frame. The size of this search window has a major impact on both the accuracy of the motion estimation (e.g., a small search window size may fail to detect fast motion) and the computational power required.

In resource constrained embedded devices with digital image capture capability such as digital cameras, cell phones, etc., the search window size may be limited due to such things as external memory bandwidth and digital image processing throughput on these devices, thus impacting the picture quality for digital image sequences with high motion such as those generated by camera panning. Accordingly, improvements in motion estimation to improve image quality in embedded devices are desirable.

### SUMMARY OF THE INVENTION

In general, in one aspect, the invention relates to a method of motion vector estimation for video encoding, the method including estimating a global motion vector for a sequence of macroblocks in a frame and estimating a motion vector for each macroblock in the sequence of macroblocks using the global motion vector to offset reference data for each macroblock.

In general, in one aspect, the invention relates to a video encoder for encoding video frames, wherein encoding a video frame includes estimating a motion vector for each macroblock in a sequence of macroblocks in the video frame using an estimated global motion vector to offset reference data for each macroblock.

In general, in one aspect, the invention relates to digital system that includes a video front end configured to receive raw video data and convert the raw video data to video frames, a memory configured to store the video frames, and a video encoder configured to encode a video frame of the video frames by estimating a motion vector for each macroblock in the sequence of macroblocks using an estimated global motion vector to offset reference data for each macroblock.

### BRIEF DESCRIPTION OF THE DRAWINGS

Particular embodiments in accordance with the invention will now be described, by way of example only, and with reference to the accompanying drawings:

FIG. 1 shows a digital system including a video encoder in accordance with one or more embodiments of the invention;

FIG. 2 shows a block diagram of a video encoder in accordance with one or more embodiments of the invention;

FIGS. 3A and 3B show examples of sliding window operation for motion estimation in accordance with one or more embodiments of the invention;

FIGS. 4A and 4B are graphs of analysis results in accordance with one or more embodiments of the invention;

FIG. 5A is a flow diagram of a method for motion estimation in accordance with one or more embodiments of the invention;

FIGS. 5B and 5C are block diagrams illustrating video stabilization in accordance with one or more embodiments of the invention;

FIGS. 6A-6D are graphs of analysis results in accordance with one or more embodiments of the invention;

FIGS. 7A-7L are graphs of test results in accordance with one or more embodiments of the invention; and

FIG. 8 shows an illustrative digital system in accordance with one or more embodiments.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Certain terms are used throughout the following description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein. Further, while various embodiments of the invention are described herein in accordance with the Simple Profile of the MPEG-4 video coding standard and/or the H.264 video coding standard, embodiments for other video coding standards will be understood by one of ordinary skill in the art. Accordingly, embodiments of the invention should not be considered limited to the MPEG-4 and H.264 video coding standards.

In general, embodiments of the invention provide methods, encoders, and digital systems that provide motion estimation techniques using estimated global motion vectors that provide improved picture resolution and picture quality in digital image sequences captured in digital cameras and other devices using embedded systems for digital image capture. More specifically, embodiments of the invention estimate motion for each macroblock in a sequence of macroblocks in a frame using a global motion vector estimated for the sequence of macroblocks. In one or more embodiments of the invention, this global motion vector is estimated using information available from performing video stabilization on the macroblocks. In some embodiments of the invention, this global motion vector is estimated using motion vectors of corresponding macroblocks in a frame, e.g., an inter-predicted frame (i.e., a P-picture or P-frame) preceding the frame in a digital image sequence. The estimated global motion vector is then used to offset reference data used for motion estimation of the macroblocks. Further, in some embodiments of the invention, the sequence of macroblocks includes all macroblocks in the frame. That is, a global motion vector is estimated using one the previously mentioned estimation techniques and is applied to offset the reference data for all macroblocks in the frame.

Embodiments of the encoders and methods described herein may be provided on any of several types of digital systems: digital signal processors (DSPs), general purpose programmable processors, application specific circuits, or systems on a chip (SoC) such as combinations of a DSP and a reduced instruction set (RISC) processor together with various specialized programmable accelerators. A stored program in an onboard or external (flash EEP) ROM or FRAM may be used to implement the video signal processing. Analog-to-digital converters and digital-to-analog converters provide coupling to the real world, modulators and demodulators (plus antennas for air interfaces) can provide coupling for transmission waveforms, and packetizers can provide formats for transmission over networks such as the Internet.

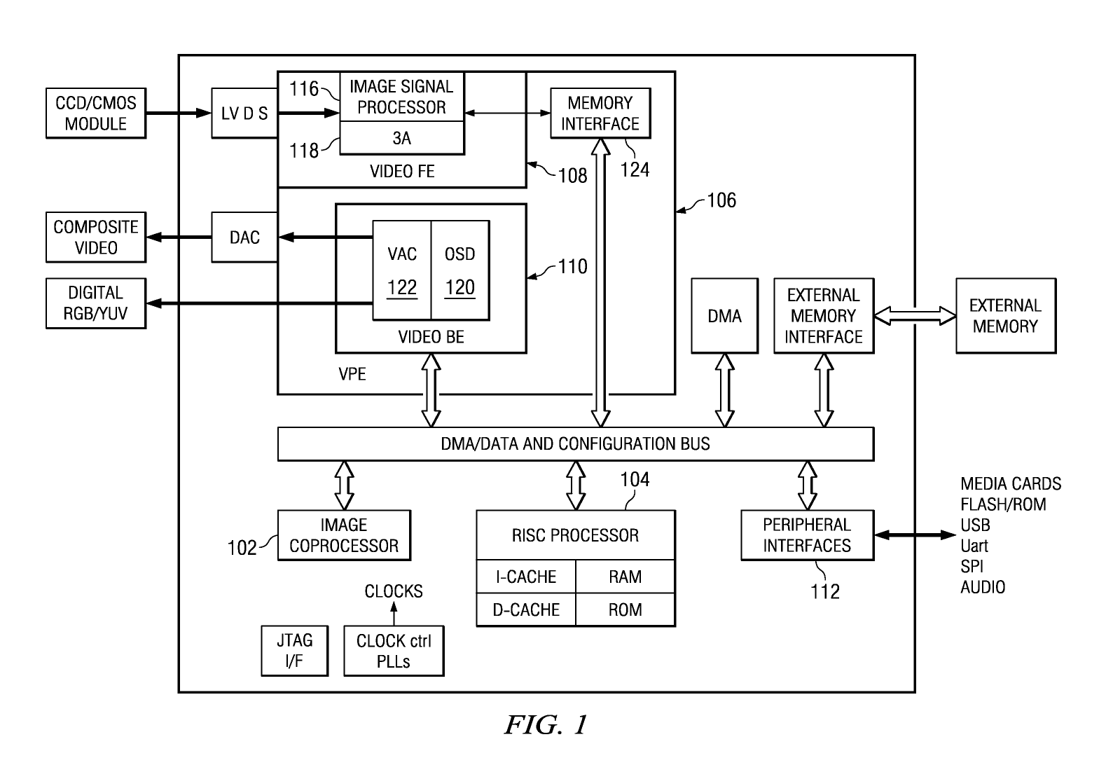

FIG. 1 shows a digital system suitable for an embedded system in accordance with one or more embodiments of the invention that includes, among other components, a DSP-based image coprocessor (ICP) (102), a RISC processor (104), and a video processing engine (VPE) (106) that may be configured to perform the motion estimation methods described herein. The RISC processor (104) may be any suitably configured RISC processor. The VPE (106) includes a configurable video processing front-end (Video FE) (108) input interface used for video capture from imaging peripherals such as image sensors, video decoders, etc., a configurable video processing back-end (Video BE) (110) output interface used for display devices such as SDTV displays, digital LCD panels, HDTV video encoders, etc, and memory interface (124) shared by the Video FE (108) and the Video BE (110). The digital system also includes peripheral interfaces (112) for various peripherals that may include a multi-media card, an audio serial port, a Universal Serial Bus (USB) controller, a serial port interface, etc.

The Video FE (108) includes an image signal processor (ISP) (116), and a 3A statistic generator (3A) (118). The ISP (116) provides an interface to image sensors and digital video sources. More specifically, the ISP (116) may accept raw image/video data from a sensor (CMOS or CCD) and can accept YUV video data in numerous formats. The ISP (116) also includes a parameterized image processing module with functionality to generate image data in YCbCr format from raw CCD/CMOS data. The ISP (116) is customizable for each sensor type and supports video frame rates for preview displays of captured digital images and for video recording modes. The ISP (116) also includes, among other functionality, an image resizer, statistics collection functionality, and a boundary signal calculator. The 3A module (118) includes functionality to support control loops for auto focus, auto white balance, and auto exposure by collecting metrics on the raw image data from the ISP (116) or external memory.

The Video BE (110) includes an on-screen display engine (OSD) (120) and a video analog encoder (VAC) (122). The OSD engine (120) includes functionality to manage display data in various formats for several different types of hardware display windows and it also handles gathering and blending of video data and display/bitmap data into a single display window before providing the data to the VAC (122) in YCbCr format. The VAC (122) includes functionality to take the display frame from the OSD engine (120) and format it into the desired output format and output signals required to interface to display devices. The VAC (122) may interface to composite NTSC/PAL video devices, S-Video devices, digital LCD devices, high-definition video encoders, DVI/HDMI devices, etc.

The memory interface (124) functions as the primary source and sink to modules in the Video FE (108) and the Video BE (110) that are requesting and/or transferring data to/from external memory. The memory interface (124) includes read and write buffers and arbitration logic.

The ICP (102) includes functionality to perform the computational operations required for video compression. The video compression standards supported may include one or more of the JPEG standards, the MPEG standards, and the H.26x standards. In one or more embodiments the ICP (102) is configured to support MPEG-4 Simple Profile at HD (720p) and JPEG encode/decode up to 50M pixels per minute. In one or more embodiments of the invention, the ICP (102) is configured to perform the computational operations of the motion estimation methods described herein.

In operation, to capture a video sequence, video signals are received by the video FE (108) and converted to the input format needed to perform video compression. The video data generated by the video FE (108) is stored in the external memory. The video data is then encoded, i.e., compressed. During the compression process, the video data is read from the external memory and the compression computations on this video data are performed by the ICP (102). As part of the compression computations, a method for motion estimation is performed as described herein. The resulting compressed video data is stored in the external memory. The compressed video data is then read from the external memory, decoded, and post-processed by the video BE (110) to display the video sequence.

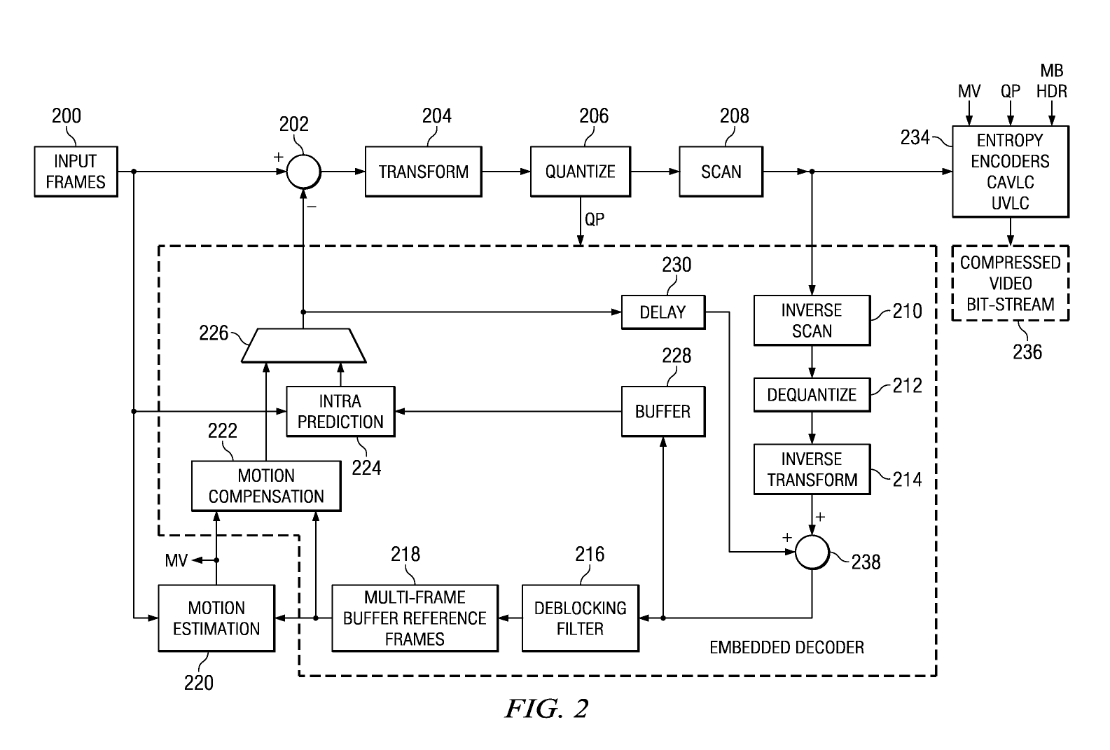

FIG. 2 shows a block diagram of a video encoder in accordance with one or more embodiments of the invention. More specifically, FIG. 2 shows the basic coding architecture of an H.264 encoder. In one or more embodiments of the invention, this architecture may be implemented in hardware and/or software on the digital system of FIG. 1. Embodiments of the methods for motion estimation described below may be provided as part of the motion estimation component (220). More specifically, for each macroblock, the output of the motion estimation component (220) is a set of motion vectors (MVs) and the corresponding mode, which may be selected using methods described below.

In the video encoder of FIG. 2, input frames (200) for encoding are provided as one input of a motion estimation component (220), as one input of an intraframe prediction component (224), and to a positive input of a combiner (202) (e.g., adder or subtractor or the like). The frame storage component (218) provides reference data to the motion estimation component (220) and to the motion compensation component (222). The reference data may include one or more previously encoded and decoded frames. The motion estimation component (220) provides motion estimation information to the motion compensation component (222) and the entropy encoders (234). Specifically, the motion estimation component (220) provides the selected motion vector (MV) or vectors and the selected mode to the motion compensation component (222) and the selected motion vector (MV) to the entropy encoders (234). The motion compensation component (222) provides motion compensated prediction information to a selector switch (226) that includes motion compensated interframe macroblocks and the selected mode. The intraframe prediction component also provides intraframe prediction information to switch (226) that includes intraframe prediction macroblocks.

The switch (226) selects between the motion-compensated interframe macro blocks from the motion compensation component (222) and the intraframe prediction macroblocks from the intraprediction component (224) based on the selected mode. The output of the switch (226) (i.e., the selected prediction MB) is provided to a negative input of the combiner (202) and to a delay component (230). The output of the delay component (230) is provided to another combiner (i.e., an adder) (238). The combiner (202) subtracts the selected prediction MB from the current MB of the current input frame to provide a residual MB to the transform component (204). The transform component (204) performs a block transform, such as DCT, and outputs the transform result. The transform result is provided to a quantization component (206) which outputs quantized transform coefficients. Because the DCT transform redistributes the energy of the residual signal into the frequency domain, the quantized transform coefficients are taken out of their raster-scan ordering and arranged by significance, generally beginning with the more significant coefficients followed by the less significant by a scan component (208). The ordered quantized transform coefficients provided via a scan component (208) are coded by the entropy encoder (234), which provides a compressed bitstream (236) for transmission or storage.

Inside every encoder is an embedded decoder. As any compliant decoder is expected to reconstruct an image from a compressed bitstream, the embedded decoder provides the same utility to the video encoder. Knowledge of the reconstructed input allows the video encoder to transmit the appropriate residual energy to compose subsequent frames. To determine the reconstructed input, the ordered quantized transform coefficients provided via the scan component (208) are returned to their original post-DCT arrangement by an inverse scan component (210), the output of which is provided to a dequantize component (212), which outputs estimated transformed information, i.e., an estimated or reconstructed version of the transform result from the transform component (204). The estimated transformed information is provided to the inverse transform component (214), which outputs estimated residual information which represents a reconstructed version of the residual MB. The reconstructed residual MB is provided to the combiner (238). The combiner (238) adds the delayed selected predicted MB to the reconstructed residual MB to generate an unfiltered reconstructed MB, which becomes part of reconstructed frame information. The reconstructed frame information is provided via a buffer (228) to the intraframe prediction component (224) and to a filter component (216). The filter component (216) is a deblocking filter (e.g., per the H.264 specification) which filters the reconstructed frame information and provides filtered reconstructed frames to frame storage component (218).

As previously mentioned, in resource constrained embedded devices such as the digital system of FIG. 1, the search range for motion estimation is often limited due to external memory bandwidth and the digital image processing throughput of the devices. For example, in some embedded devices, the search range for motion estimation may be limited to ±7.5 and the search center may be fixed at 0,0 for all macroblocks. In addition, a sliding window approach for accessing the reference data (i.e., reference pixels) for motion estimation is used to further mitigate external memory bandwidth issues. This sliding window approach takes advantage of the fact that reference data used for motion estimation of a sequence of macroblocks overlaps, i.e., at least a part of the reference data used for a macroblock is also used for motion estimation of the subsequent macroblock.

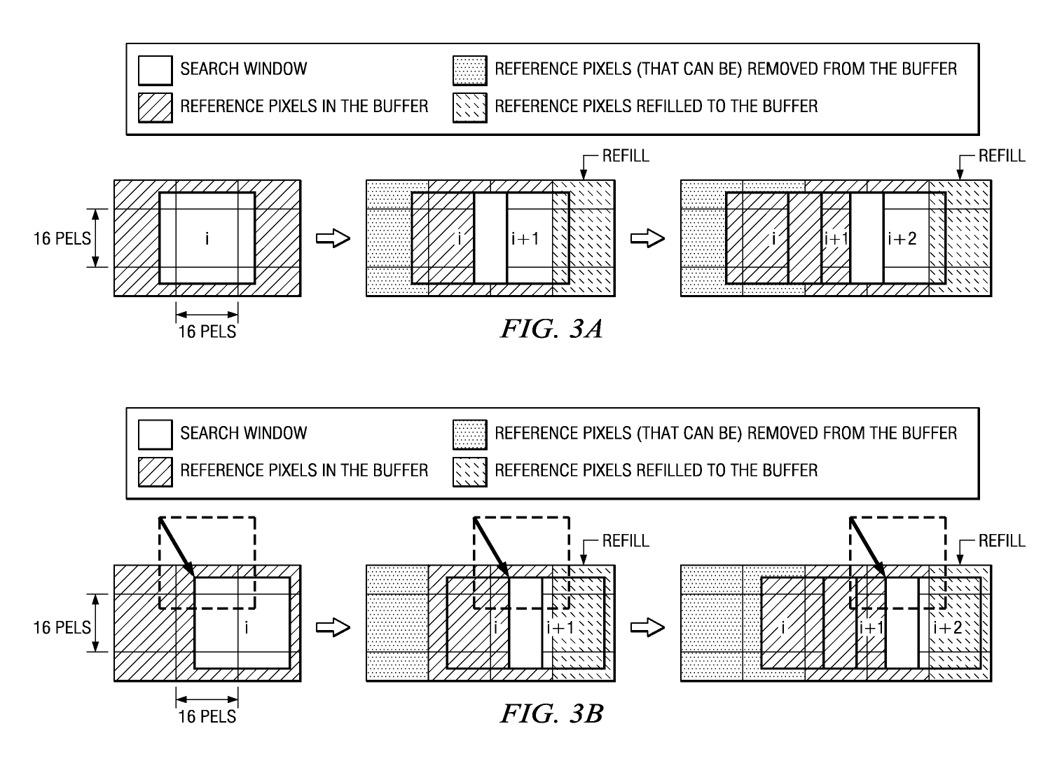

FIG. 3A shows an example of the sliding window operation for motion estimation. In this example, a buffer holds reference data from previously encoded macroblocks in a video sequence that is needed for performing motion estimation for the macroblocks to be encoded. For a macroblock i, reference data from external memory that encloses the search window is loaded into the buffer, the search is performed, and the motion for macroblock i is estimated. This reference data for macroblock i overlaps the reference data needed for motion estimation for macroblock i+1. Therefore, rather than completely reloading the buffer with the reference data for macroblock i+1, a part of the reference data used for macroblock i that does not overlap the reference data needed for macroblock i+1 may be removed from the buffer, new reference data of the same size as the removed data is read from external memory into the buffer, and the search window is moved (i.e., “slides”) to a new location within the buffer that contains the reference data for macroblock i+1. Similarly, the reference data for macroblock i+1 overlaps that needed for macroblock i+2, and thus, part of the reference data for macroblock i+1 may be removed from the buffer and new reference data of the same size read from external memory. In this example, the width of the reference data that may be removed and the width of the reference data for “refilling” is 16 pels and the search center is fixed at 0,0.

Due to search range and search center limitations, the quality of video image sequences with high motion, e.g., panning sequences, is degraded. However, the quality is improved for many video image sequences when the search center used during motion estimation is adjusted without altering the search range. As is explained in more detail below, the quality is improved if the search center is offset by an estimated global motion vector.

The sliding window approach does not require that the search center be fixed at 0,0. Rather, this approach can be used as long as the search center for all macroblocks in a row of a frame or for all macroblocks in a frame is offset by the same amount. FIG. 3B shows an example of the sliding window operation with a common offset. In this figure, the dotted squares represent the position of the current macroblock and the blue arrows represent the common offset into the reference data for each macroblock.

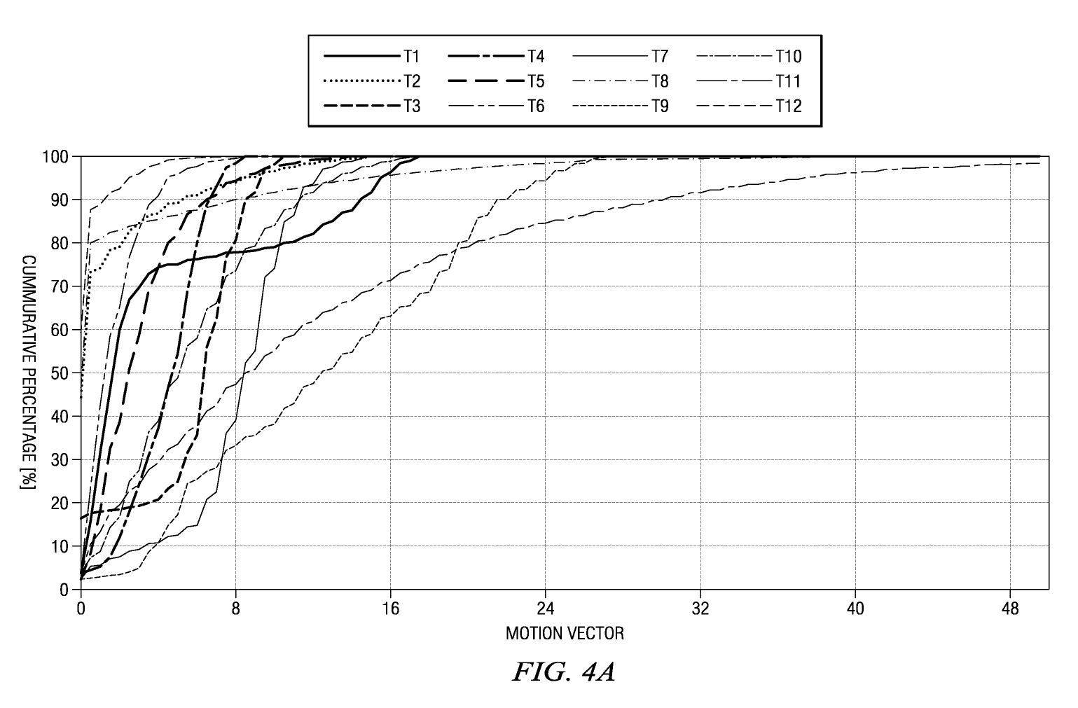

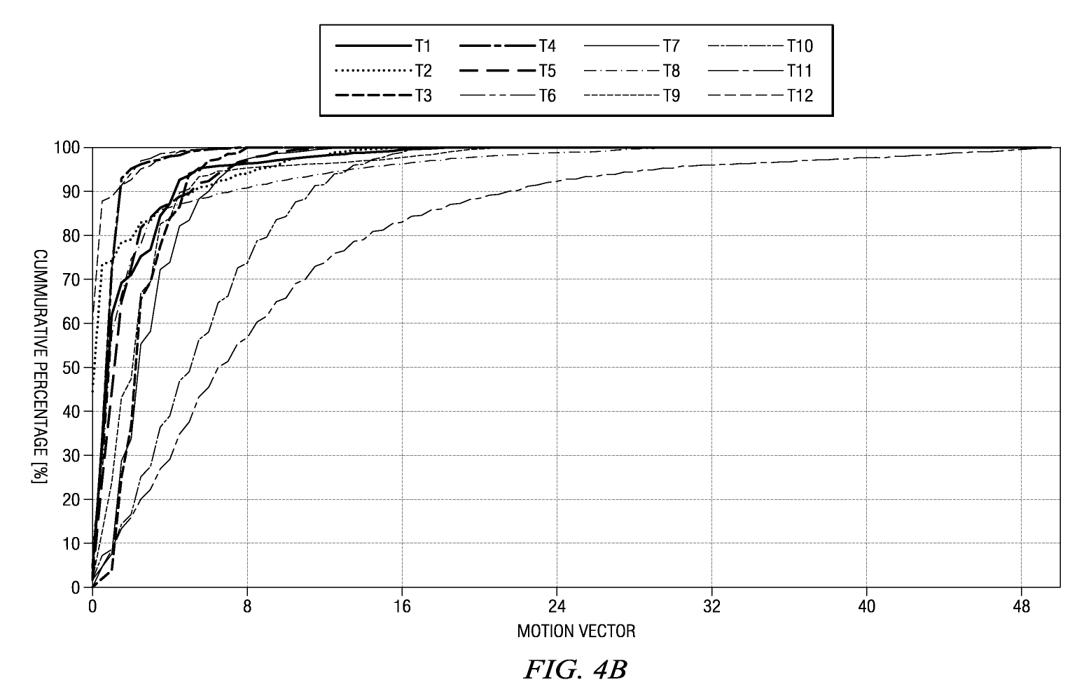

Further, analysis of some test video sequences with varying amounts of motion shows that using an estimated global motion vector as the common offset provides more effective motion estimation. FIGS. 4A and 4B are graphs illustrating the results of the analysis. For the analysis, the test video sequences were encoded by a commercially available software video encoder using the best motion estimation provided by the video encoder. FIG. 4A shows the distribution of the motion vectors in the encoded bit streams of the test video sequences. The x-axis represents the motion vector length, i.e., the absolute value of the longer of the horizontal or vertical component of the motion vector and the y-axis shows how many motion vectors were less than or equal to each length. For example, for the flower video sequence, about 75% of the motion vectors are less than or equal to 8.0 pel. A motion estimation algorithm with a limited search range of (±7.5×±7.5) can handle motion vectors that are shorter than 8.0 pel. However, if this limited search range is used for higher motion sequences, as is apparent from the graph of FIG. 4A, appropriate motion vectors would be found for only 33% of the motion in the T9 video sequence, 40% of the motion in the T7 video sequence, 50% of the motion in the T11 video sequence, and 75% of the motion in the T1 video sequence, thus yielding degraded image quality for these video sequences.

For the next part of the analysis, the average motion vector for each frame (i.e., the average of the motion vectors for each macroblock in the frame) in each of the test video sequences was calculated. These average motion vectors roughly approximate the global motion for each frame. The average motion vector of a frame was subtracted from the motion vectors of each macroblock of the frame to determine the differential motion vectors. FIG. 4B shows the distribution of these differential motion vectors. Note that this distribution is much steeper than that of the raw motion vectors shown in FIG. 4A. This result suggests that much more motion can be covered using a search window of the same size by shifting the search center according to the estimated global motion of a frame. For example, with the same (±7.5×±7.5) search window, 95% of the motion in the T9 video sequence, the T7 video sequence, and the T1 video sequence is covered. The T11 and T10 video sequences are not simple camera panning sequences, but rather include complicated moving objects. These results show that use of the estimated global motion vector with a fixed, limited size search window is not very effective for such video sequences. However, this analysis shows that higher image quality can be achieved for most of the test video sequences by using a frame-wide common offset, i.e., the estimated global motion of the frame, to the search center for motion estimation.

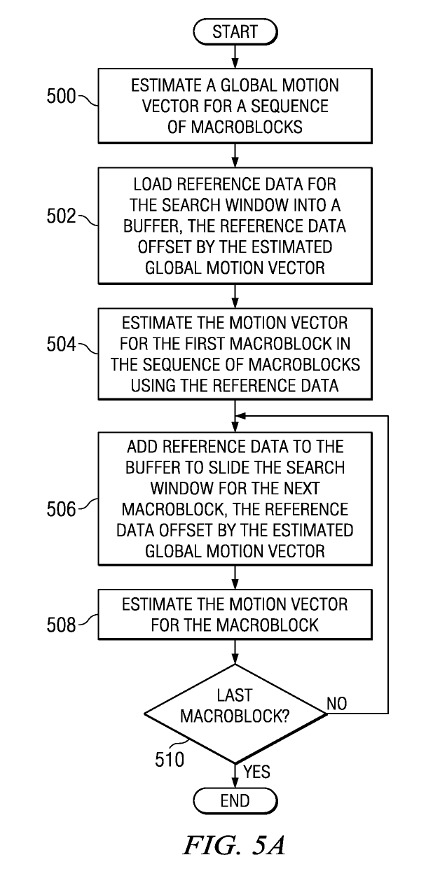

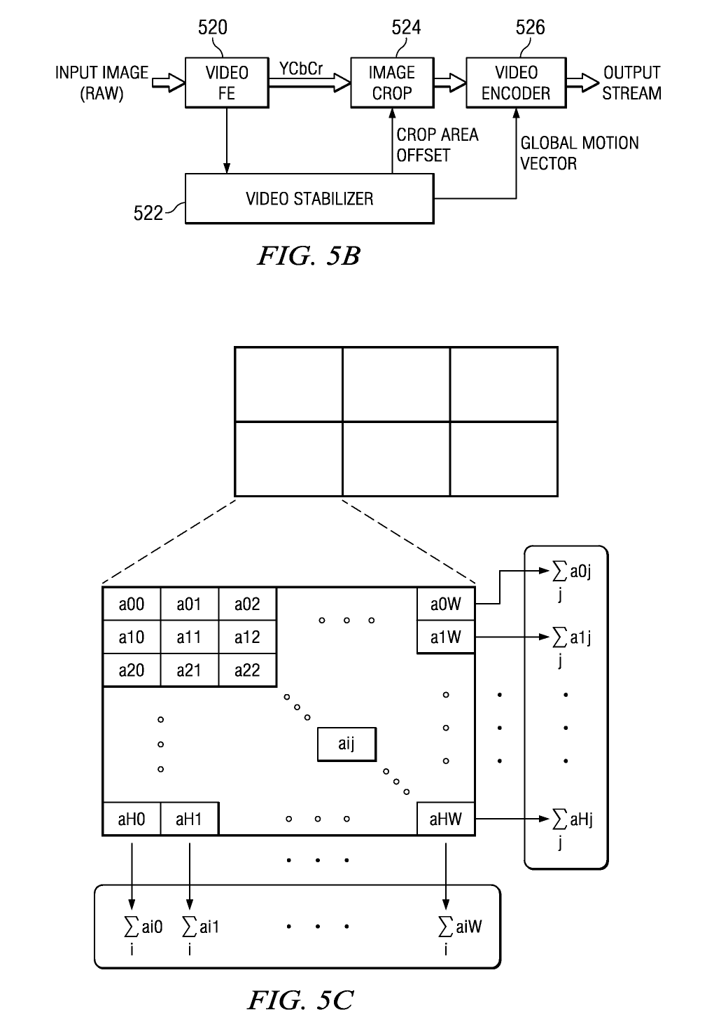

FIG. 5A shows a method for motion estimation using a common offset to the search center in accordance with one or more embodiments of the invention. Initially, a global motion vector is estimated for a sequence of macroblocks in a frame (500). In one or more embodiments of the invention, the sequence of macroblocks is a row in the frame. In other embodiments of the invention, the sequence of macroblocks includes every macroblock in the frame.

In some embodiments of the invention, the global motion vector is estimated using interim data from a video stabilization process. A video stabilization process detects global motion in a video sequence and uses this global motion to mitigate the effects of camera shaking in the resulting encoded images. In one or more embodiments of the invention, the video stabilization process estimates the global motion vector for the sequence of macroblocks and provides the estimated global motion vector to the video encoder. FIG. 5B shows a block diagram of the data flow for video stabilization in a digital system, e.g. the digital system of FIG. 1.

As shown in FIG. 5B, the video FE (520) accepts the raw input image data and converts this data to frames in YCbCr format. Each frame is then provided to the image crop module (524). The video FE (520) also provides information about each frame to the video stabilizer module (522). More specifically, as shown in the example of FIG. 5C, in one or more embodiments of the invention, the video FE (520) includes functionality to divide each frame into a number of equal sized sections of macroblocks (e.g., six 3×2 sections) and add the pixels in each section both horizontally and vertically. The resulting values for the sections are provided to the video stabilizer module (522).

The video stabilizer component (522) uses the values from the video FE (520) to analyze the overall scene movement. As part of this analysis, the video stablilizer component (522) calculates global motion vectors for each frame that are used for estimating the motion in the frame. More specifically, in one or more embodiments of the invention, the video stabilizer component (522) determines a global motion vector for each section of the frame using the values for the section received from the video FE (520) and calculates the global motion vector for the frame using the global motion vectors for the sections. The global motion vector for the frame may be determined as either the average or the median of the global motion vectors determined for the sections. The video stabilizer component (522) also extracts camera shake movement from the global motion vector and calculates the area offset for image cropping. This crop area offset is provided to the image crop component (524). The crop area offset is also used to adjust the global motion vector for the frame. That is, assuming that the global motion vector of frame i as determined by the video stabilizer component (522) is \vec{M}ᵥₛ(i), and the crop area offset (camera shake vector) is \vec{M}_{cs}(i), the global motion vector of the frame is \vec{M}(i)=\vec{M}ᵥₛ(i)−\vec{M}_{cs}(i). The video stabilizer component (522) provides the adjusted global motion vector for the frame to the video encoder (526).

The image crop component (524) crops the frames received from the video FE (520) using the crop offset values from the video stabilizer component (522) and provides the resulting frames to the video encoder (526) (e.g., the video encoder of FIG. 2). The video encoder (526) uses the global motion vectors from the video stabilizer module (522) to estimate motion in the frames received from the image crop component (524). In one or more embodiments of the invention, the video stabilizer component (522), the image crop component (524), and/or the video encoder (526) may be implemented in software and/or hardware in a digital system such as the digital system of FIG. 1.

In the experiments and analyses described herein, the crop area offset \vec{M}_{cs}(i) is assumed to be (0,0) because no camera shake movement is included in the test video sequences. However, introduction of camera shake movement should not negatively impact the global motion vector estimation, because the video stabilization component (522) shifts the offset of the global motion vectors and the center of the cropped image by the same amount.

In other embodiments of the invention, the global motion vector for the sequence of macroblocks is estimated from the motion vectors of a previously encoded frame. In one or more embodiments of the invention, when only I-frames and P-frames are used for encoding, the motion vectors from a previous P-frame are used. More specifically, the global motion vector for the sequence of macroblocks is estimated from the motion vectors of the corresponding sequence of macroblocks in a temporally adjacent P-frame in the video sequence. When the motion field in a video sequence is continuous over time, which is likely in a majority of cases, the current P-frame will have a motion field that is very close to the motion field of the previous P-frame. Therefore, the global motion vector for a sequence of macroblocks in the current P-frame is likely very close to the global motion vector for the corresponding sequence of macroblocks in the immediately previous P-frame.

Accordingly, in one or more embodiments of the invention, the global motion vector for the sequence of macroblocks in the frame is estimated by averaging the motion vectors of the corresponding macroblocks in a previous P-frame. For example, if the sequence of macroblocks includes all macroblocks in the frame, the global motion vector for the frame may be estimated as

$$\vec{M} ( i ) = \{ \begin{matrix}〈 \vec{v} ( i - 1 , x , y ) 〉 & ( if the previous picture is a P \text{-} picture ) \\ 〈 \vec{v} ( i - 2 , x , y ) 〉 & ( otherwise )\end{matrix}$$

where \vec{M}(i) denotes the estimate of the global motion in i-th frame and \vec{v}(i,x,y) denotes the motion vector of the macroblock at (x, y) in i-th frame. Note that if the frame immediately preceding the current frame is not a P-frame, i.e., it is an I-frame, the global motion vector is estimated using the P-frame preceding that I-frame. However, in some embodiments of the invention, motion vectors are available for I-frames. In such embodiments, the motion vectors for the I-frame are used instead of the motion vectors from the P-frame preceding the I-frame. Further, in other embodiments of the invention, the global motion vector for the sequence of macroblocks may be determined as the median motion vector of the corresponding sequence of macroblocks or by other suitable computation using the motion vectors for the corresponding sequence of macroblocks. In one or more embodiments of the invention, the global motion vector for the first P-frame in a video sequence is assumed to be 0,0.

In other embodiments of the invention, when B-frames are used as well as I-frames and P-frames for encoding, the motion vectors from the temporally next P-frame, are used when the frame is a B-frame, and the motion vectors from the temporally previous P-frame are used when the frame is a P-frame. For example, consider a sequence of frames I0 B1 P2 B3 P4. The global motion vector for a sequence of macroblocks in P4 is estimated from the motion vectors of the corresponding sequence of macroblocks in P2, the temporally previous P-frame. Note that motion vectors from B3 cannot be used as P4 is encoded before B3. The global motion vector for a sequence of macroblocks in B1 is also estimated from the motion vectors of the corresponding sequence of macroblocks in P2, the temporally next P-frame. Similarly, the global motion vector for a sequence of macroblocks in B3 is estimated from the motion vectors of the corresponding sequence of macroblocks in P4, the temporally next P-frame. The global motion vector for P2 is assumed to be 0,0 as P2 has no temporally previous P-frame. The global motion vector estimated for a B-frame is also scaled according to the frame distance, i.e., the average (or median) motion vector determined for the temporally next P-frame is divided by two to generate the estimated global motion vector for the B-frame.

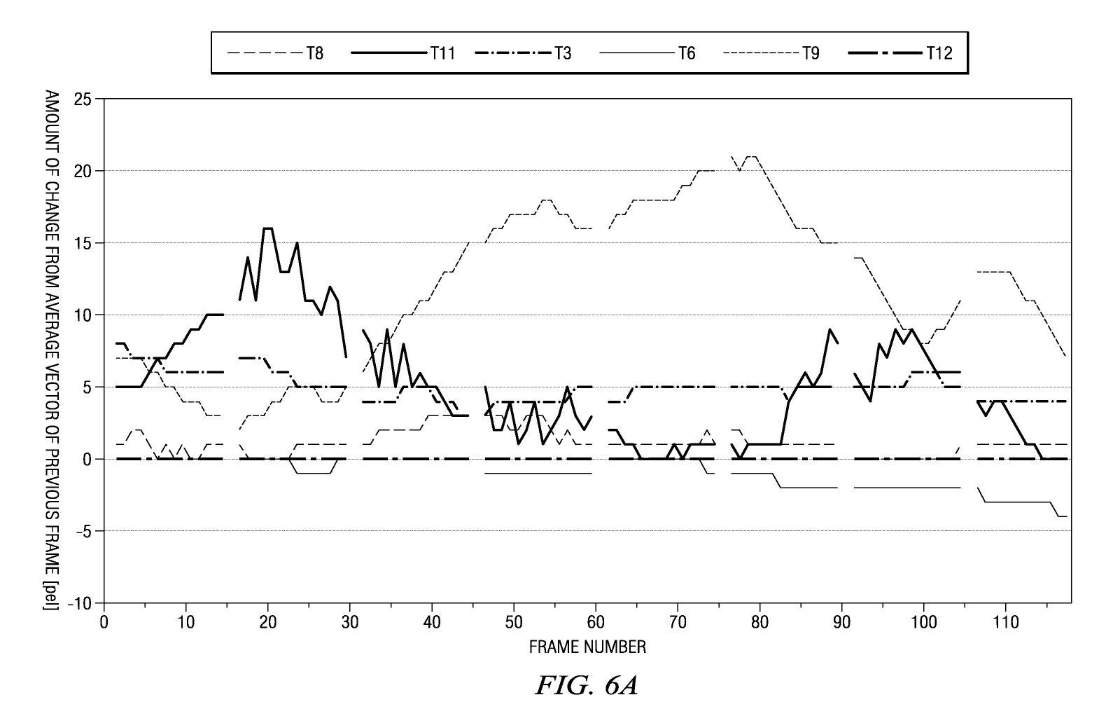

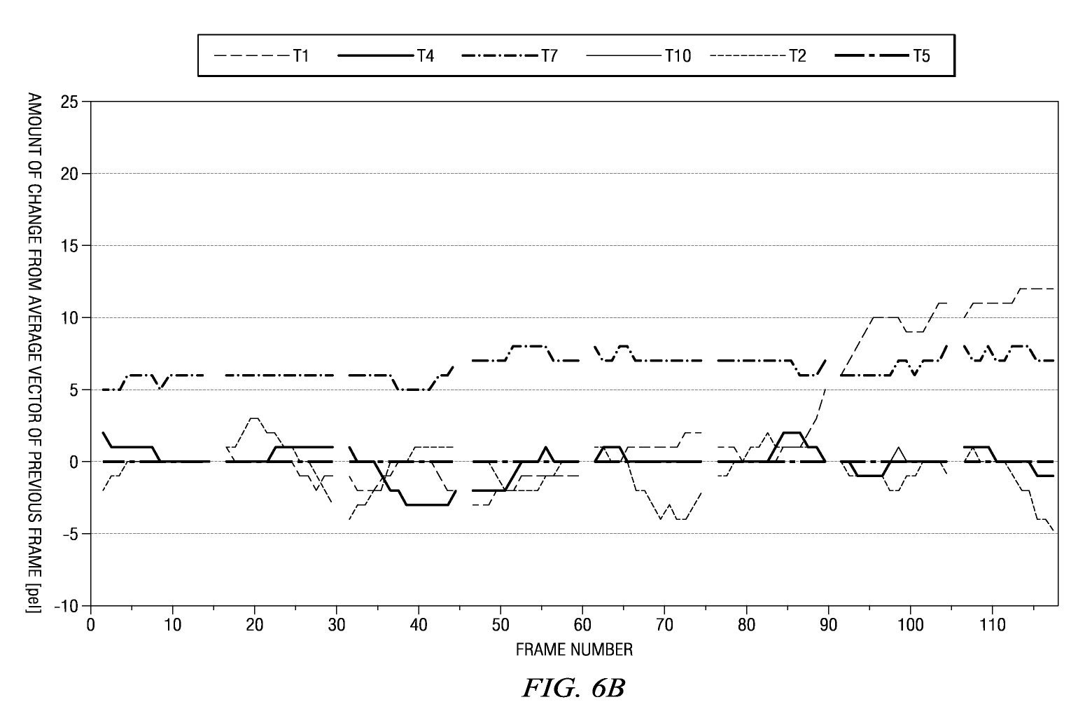

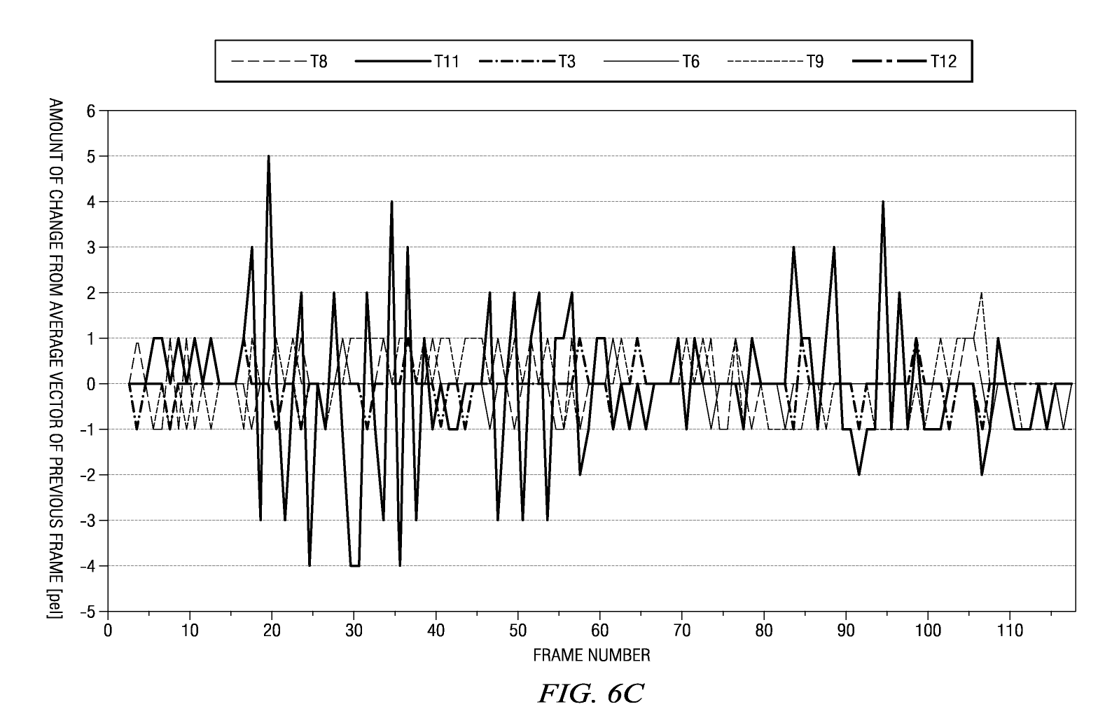

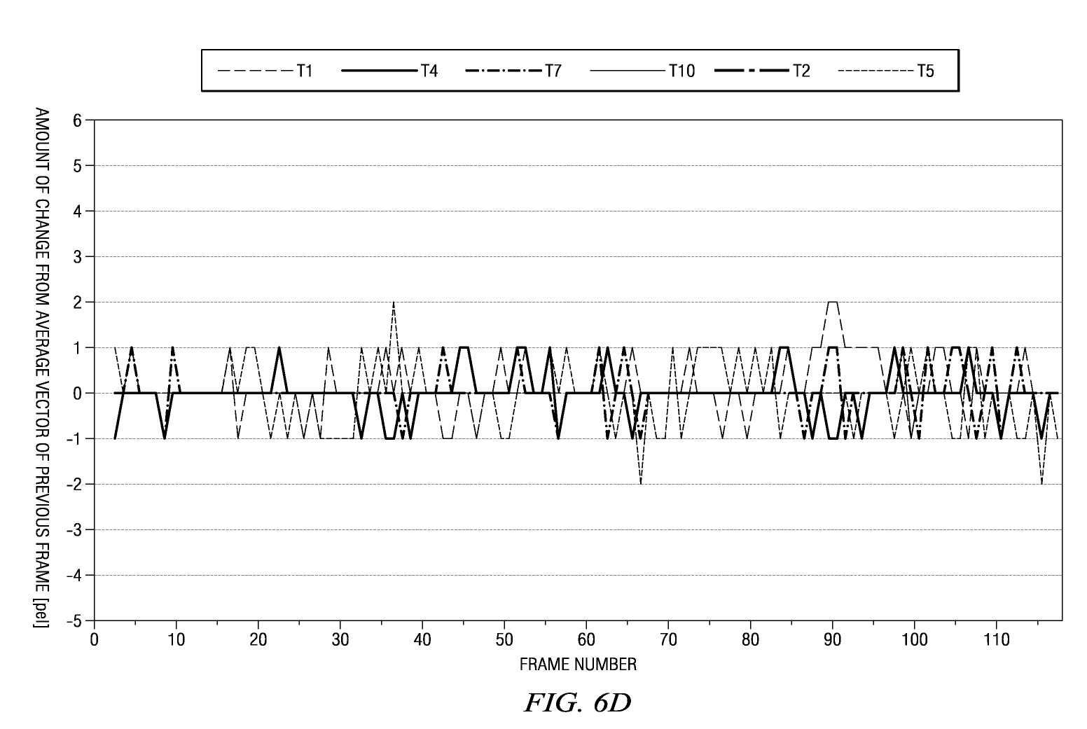

An analysis was performed using the previously mentioned test video sequences to confirm the movement of global motion vectors over time. For this analysis, the statistics of the average motion vectors from the test video encoded sequences by the software encoder were collected. FIGS. 6A and 6B show graphs of the horizontal component of the average motion vector for each frame in the test video sequences. These graphs show that the change in the motion fields is moderate at most, and implies that the motion vectors from the previous frame may be used to estimate the motion vectors for the current frame with relatively small error.

FIGS. 6C and 6D show graphs of the amount of change in the horizontal component of the average motion vector of each frame from that of the previous frame. The change between a frame period is at most ±5-pel and less than or equal to ±1 pel in most cases, thus suggesting that the global motion may be successfully tracked with a (±7.5×±7.5) search range.

Referring again to FIG. 5A, once the global motion vector is estimated for the sequence of macroblocks, reference data for the search window for the first macroblock in the sequence of macroblocks is loaded into a buffer to be used for motion estimation (502). The reference data selected for loading is offset by the estimated global motion vector. That is, the reference data that is loaded is selected from the previous frame based on a search center of (0,0) that is offset by the estimated global motion vector. The motion vector for the first macroblock is then estimated (504).

After the motion vector for the first macroblock is estimated, additional reference data is added to the buffer to slide the search window for the motion estimation for the next macroblock (506). The added reference data is also offset by the estimated global motion vector. As previously explained, the reference data used for motion estimation for consecutive macroblocks overlaps. Therefore, after the reference data for the first macroblock in a frame or row is loaded into the buffer, smaller portions of reference data can be loaded for subsequent macroblocks. The search window then “slides” to cover a portion of the reference data already in the buffer and part of the newly loaded reference data. Further, any of the older reference data in the buffer not covered by the search window may be removed from the buffer. In one or more embodiments of the invention, the portion of reference data loaded for the subsequent macroblocks and the portion of reference data removed from the buffer are 16 pels in width.

Once the reference data is added to the buffer, the motion vector for the next macroblock is estimated (508). The process of loading additional reference data offset by the estimated global motion vector for the sequence of macroblocks and estimating motion vectors is repeated until a motion vector is estimated for each macroblock in the sequence of macroblocks (504-510).

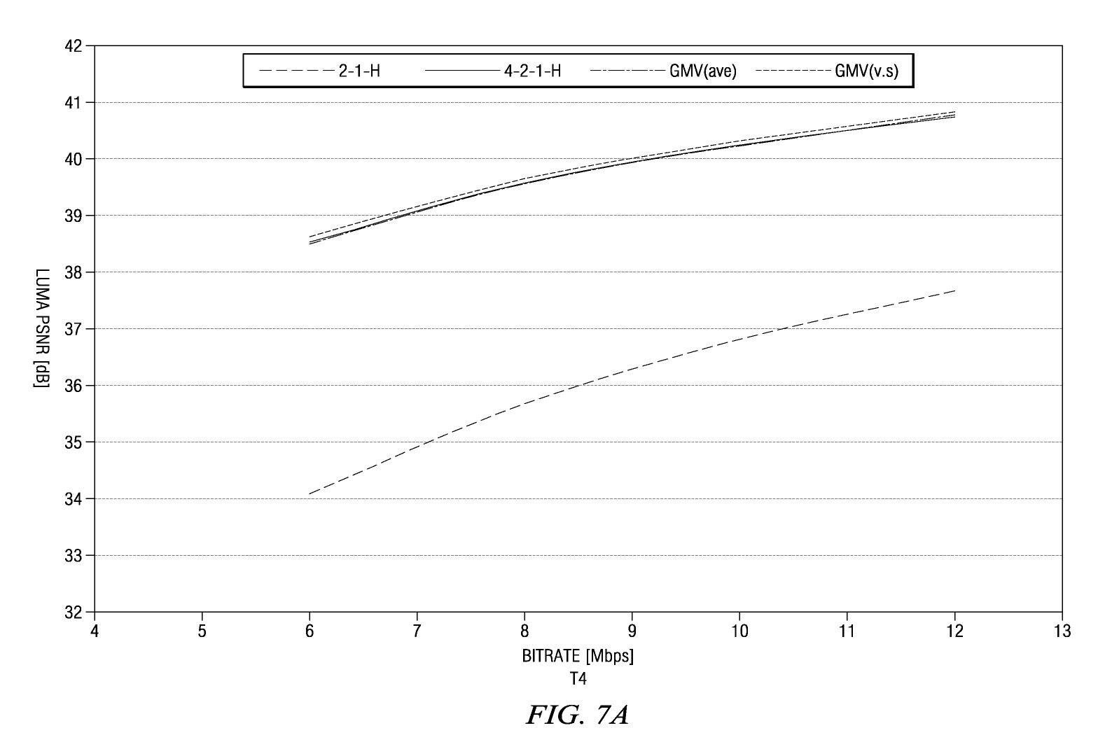

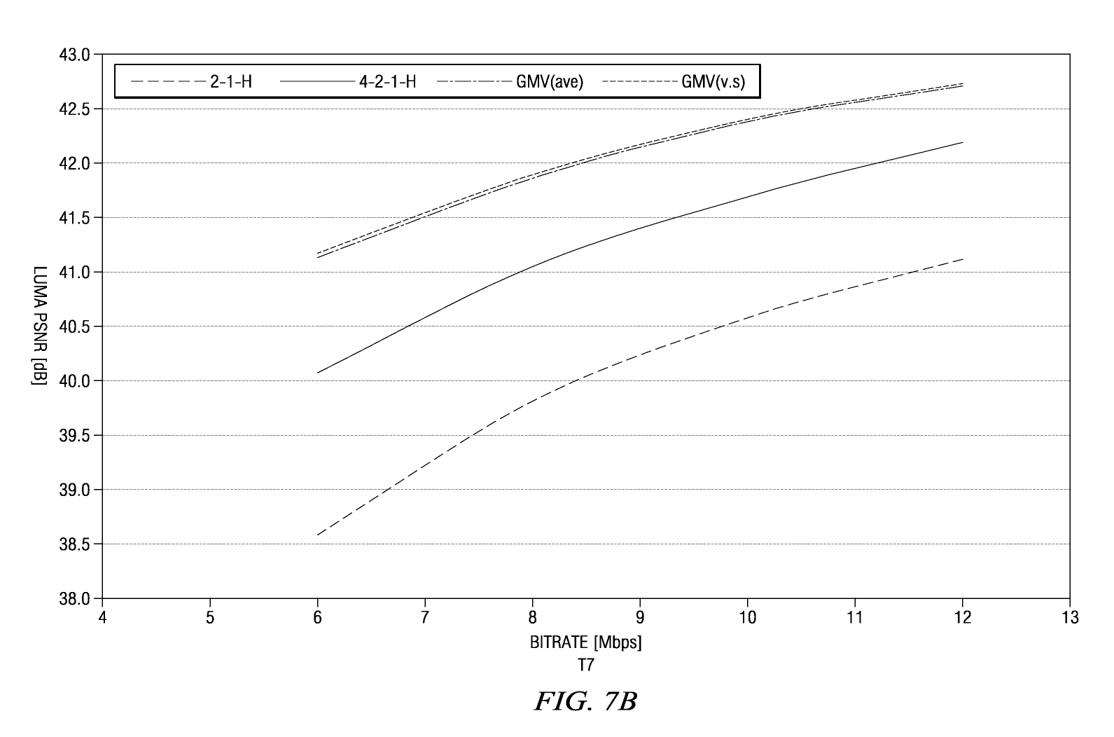

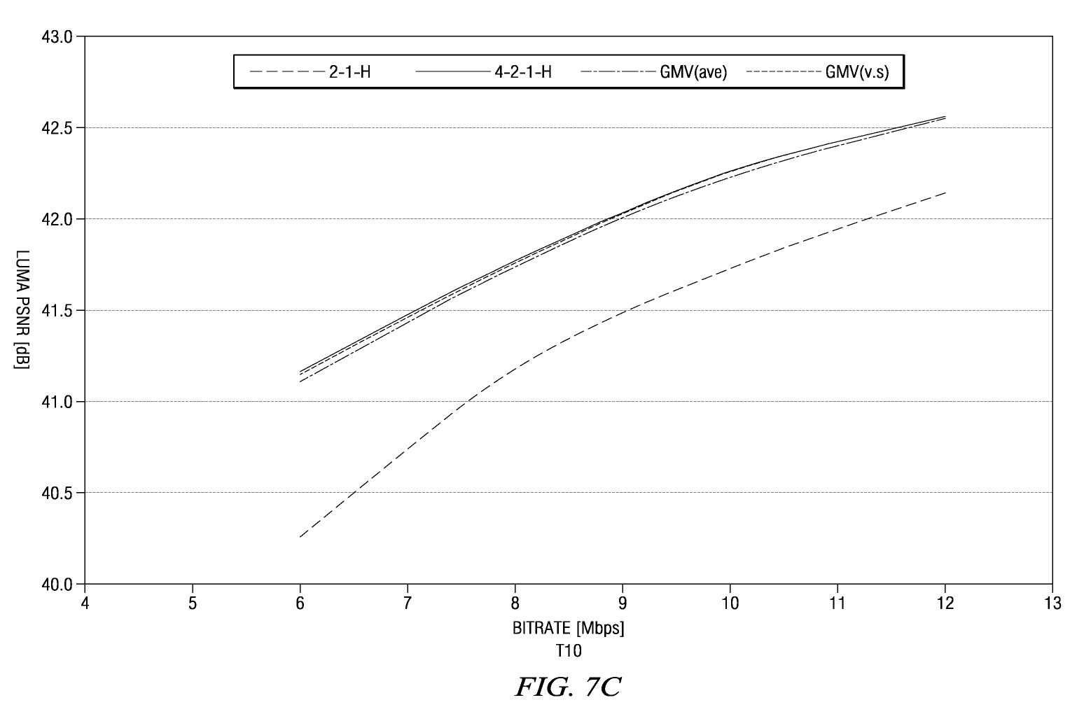

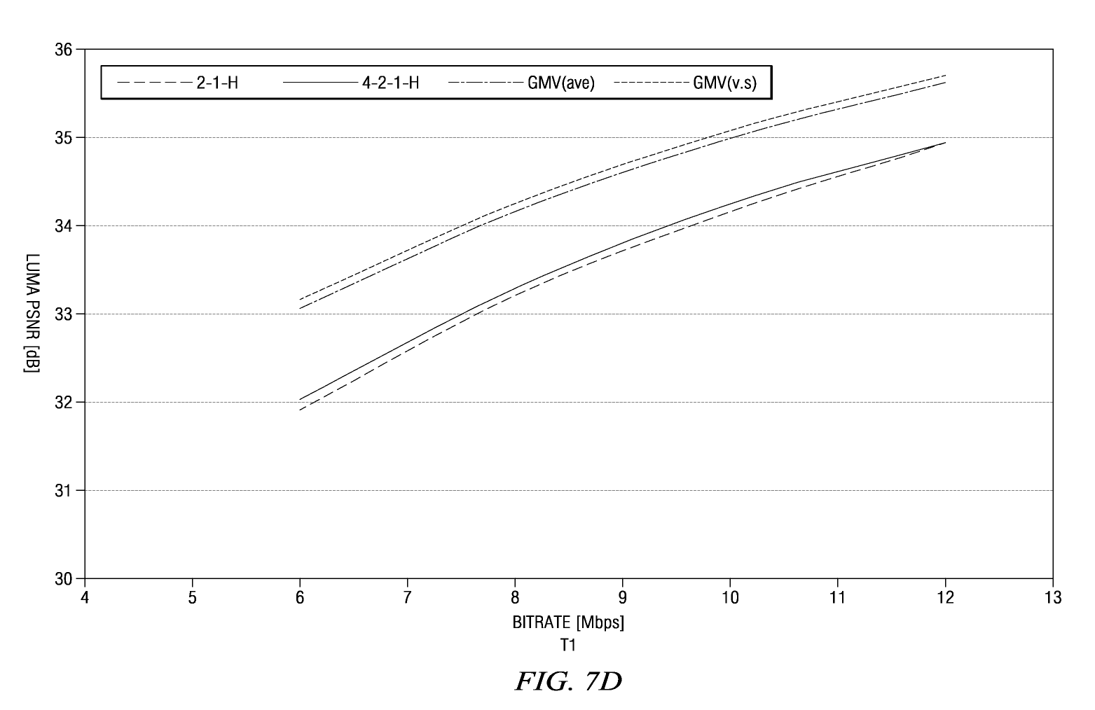

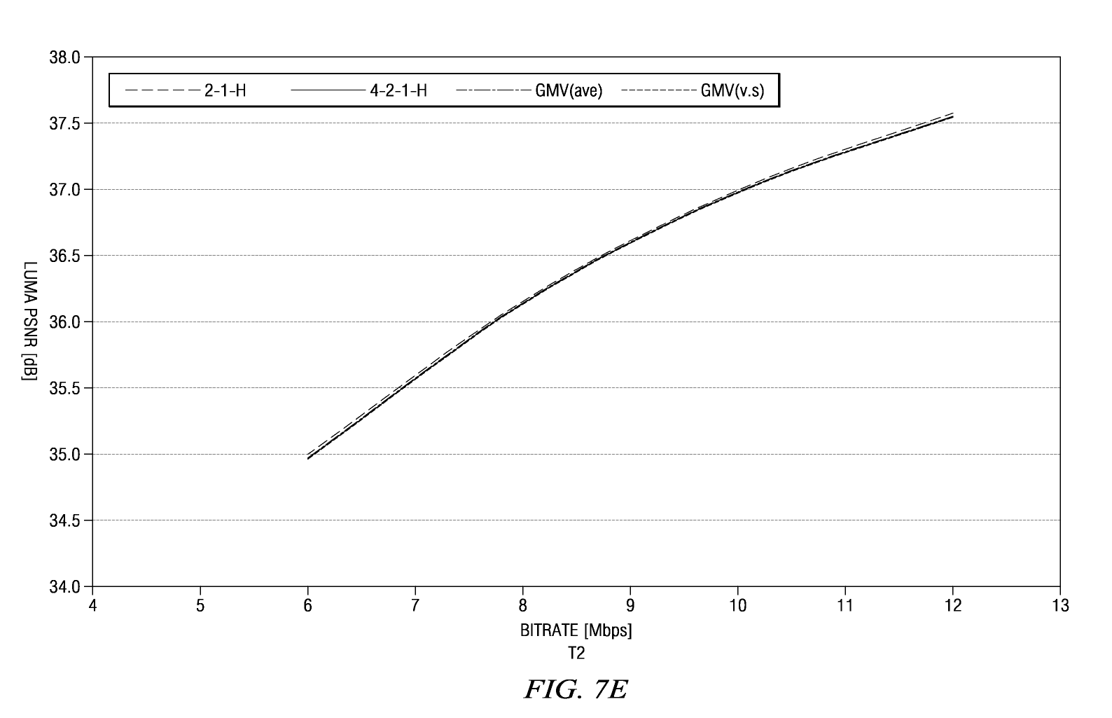

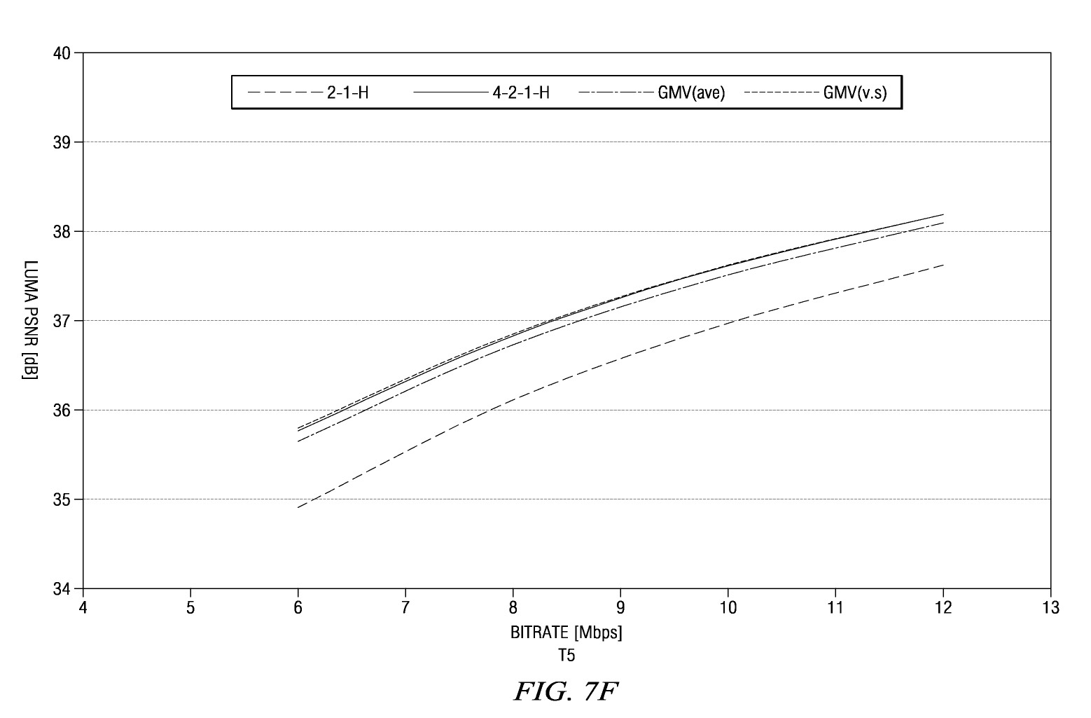

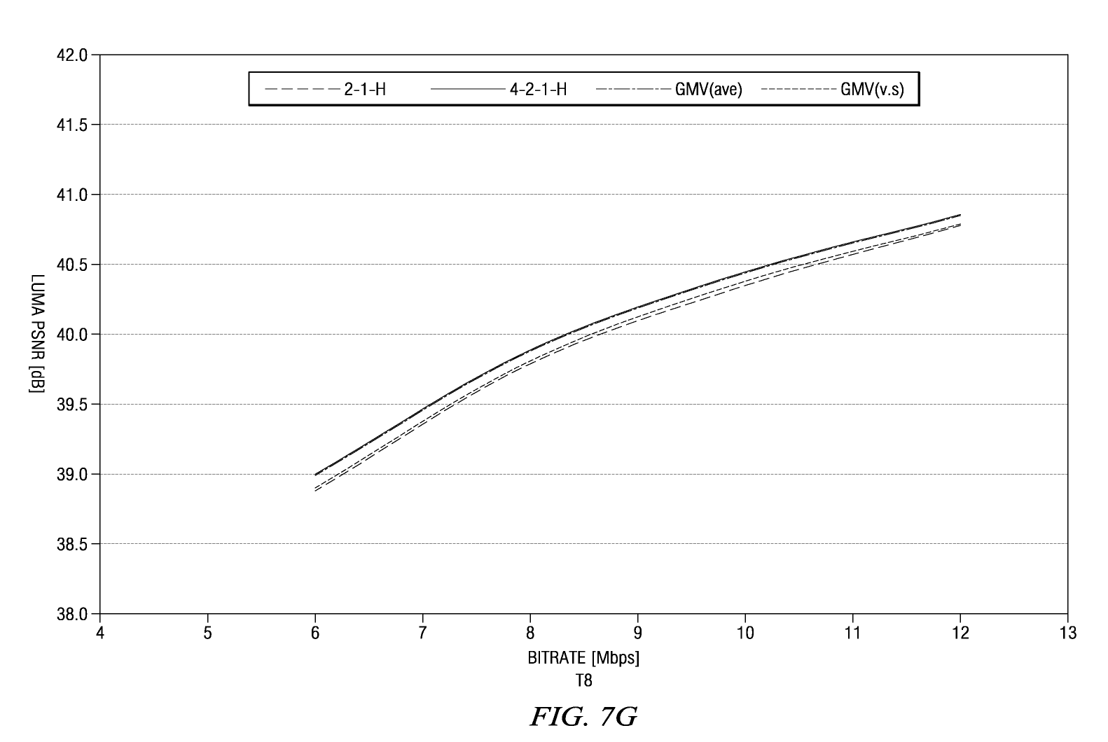

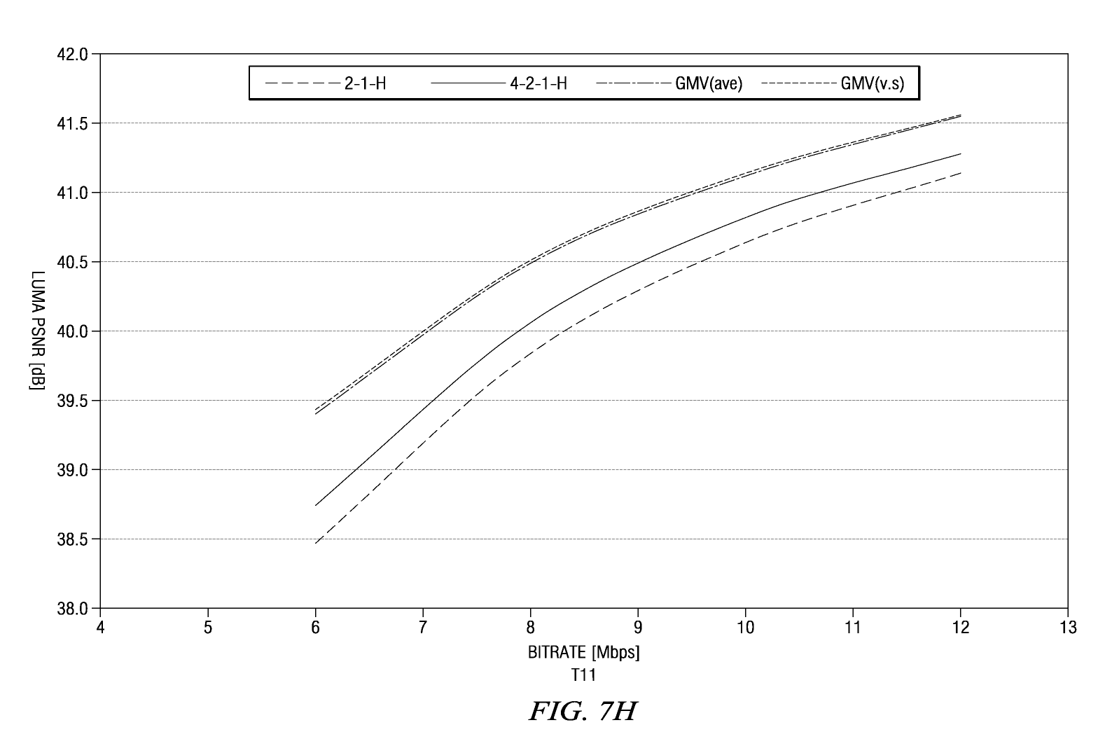

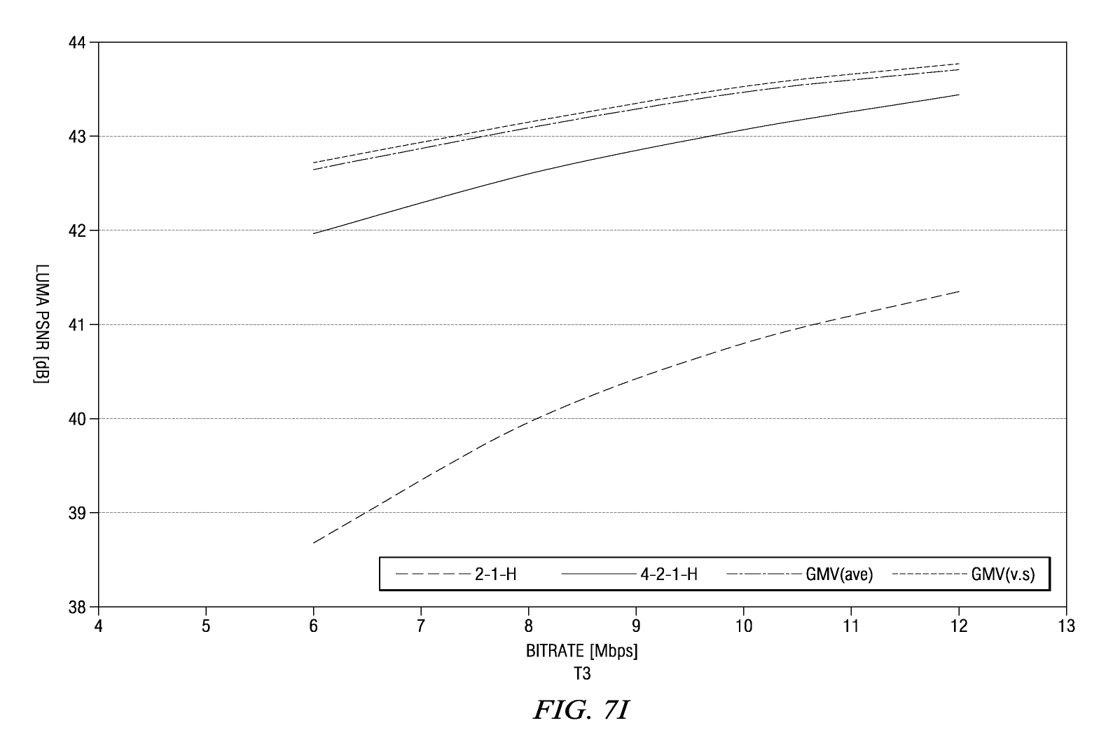

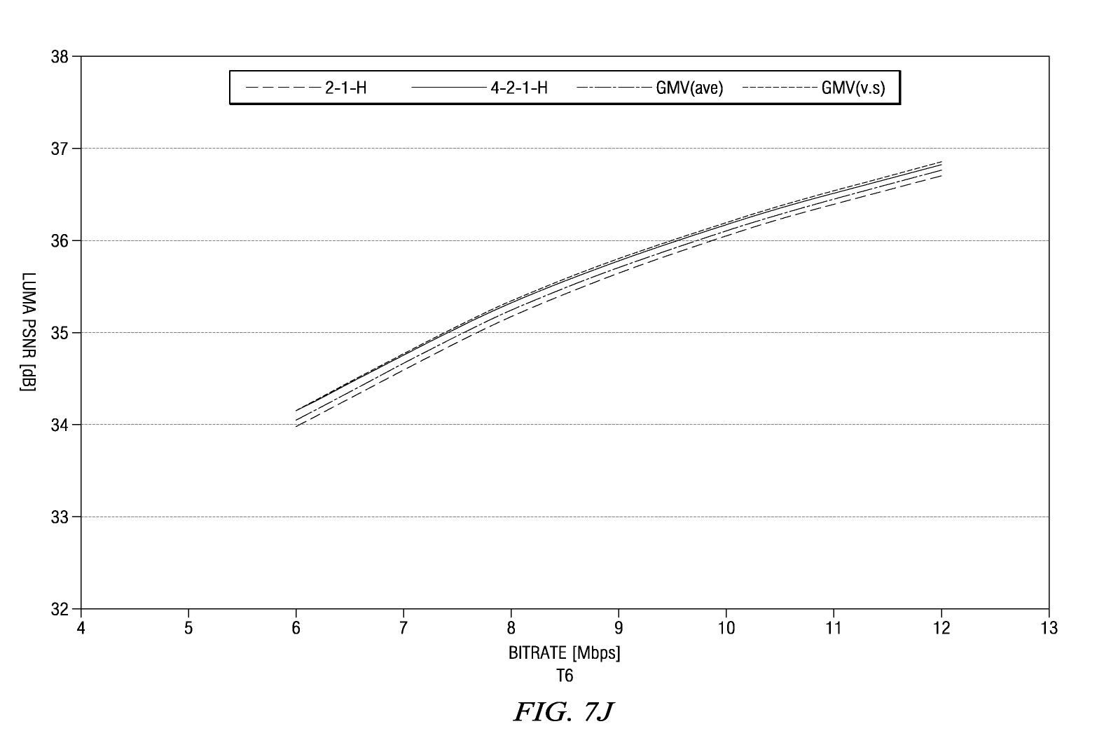

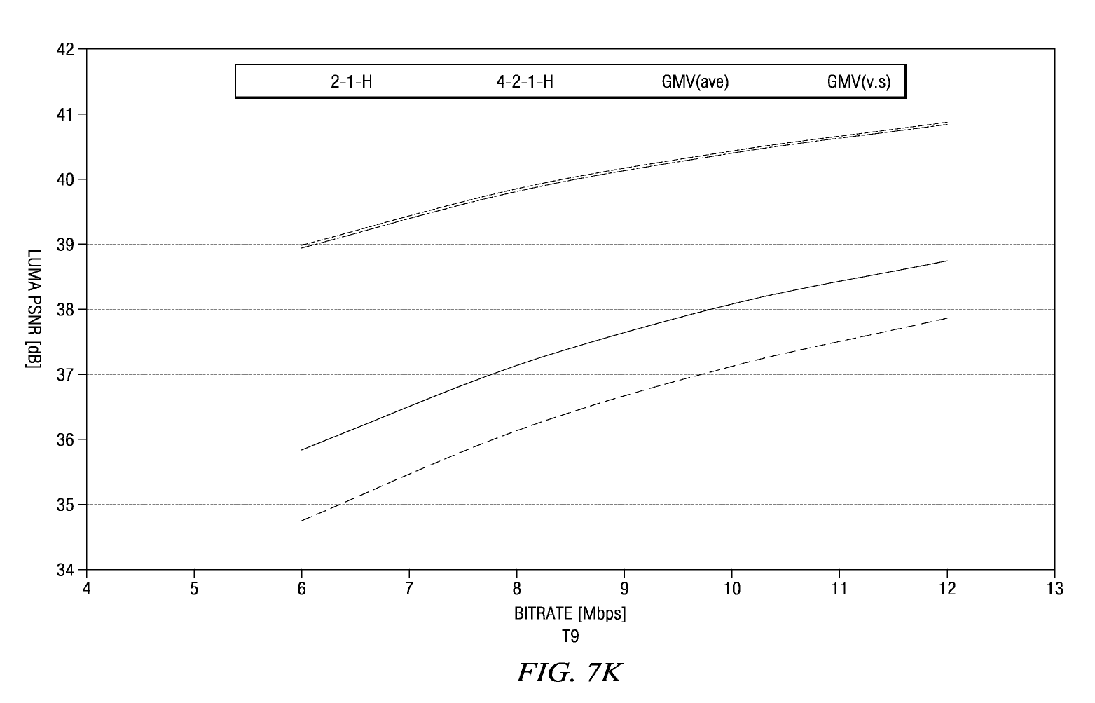

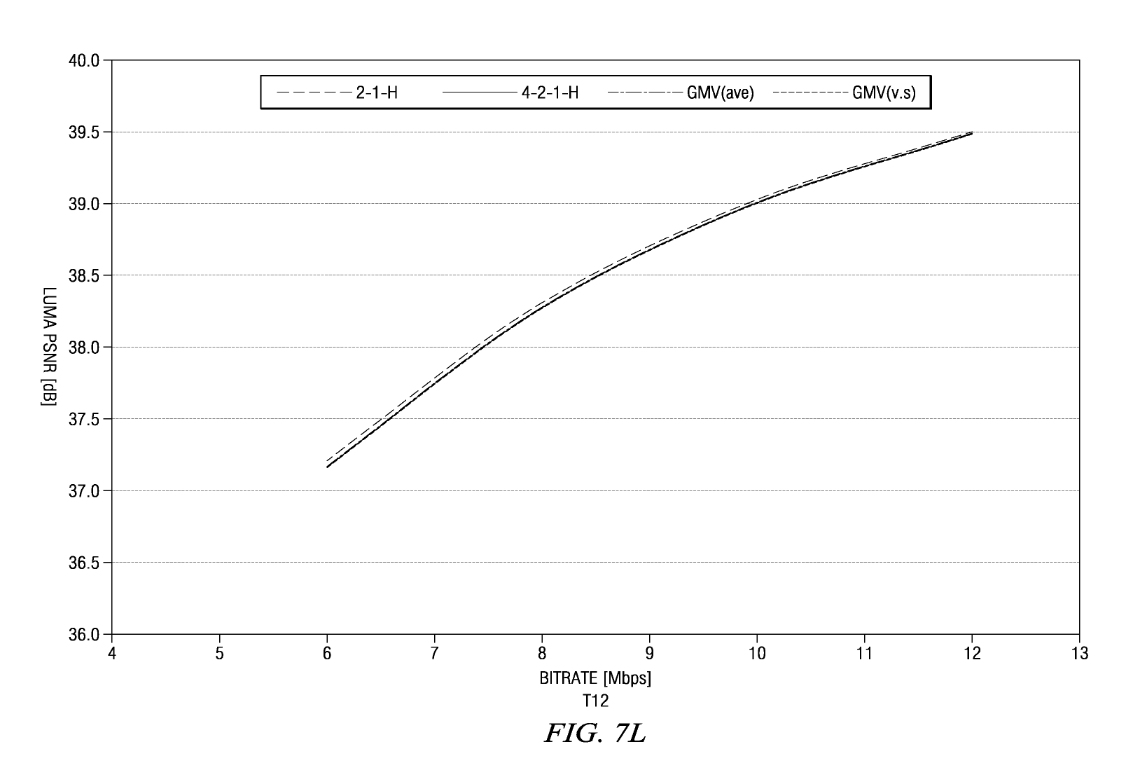

The test video sequences were encoded using a motion estimation process in which the estimated global motion vector for a frame was used to offset the reference data for each macroblock in the frame. In particular, the encoding was at a rate of 8 Mbps using ±7.5 search window for motion estimation with a 4-pel pitch followed by 2-pel, 1-pel and half pel refinement (4-2-1-H). The estimation of the global motion vector was performed using both the interim data from the video stabilizer component and using the average motion vector of the previous P-frame. FIGS. 7A-7L show the rate distortion curves for the corresponding test video sequences for 4-2-1-H motion estimation without using the estimated global motion vector offset, using the estimated global motion vector from the video stabilization component, and using the estimated global motion vector from the previous P-frame. Table 1 summarizes the picture quality improved achieved for each type of global motion vector estimation. Note that the test video sequences that included camera panning, i.e., T1 (FIG. 7D), T7 (FIG. 7B), T11 (FIG. 7H), T3 (FIG. 71), and T9 (FIG. 7K), showed the most significant improvement and the impact on other test video sequences was insignificant.

TABLE 1

Improvement from 4-2-1-H [dB]

| Sequence | Average MV | Video Stabilizer |
|---|---|---|
| T1 | +0.87 | +0.96 |
| T4 | −0.01 | +0.07 |
| T7 | +0.81 | +0.84 |
| T10 | −0.03 | −0.01 |
| T2 | +/−0 | +/−0 |
| T5 | −0.10 | +0.02 |
| T8 | +/−0 | −0.07 |
| T11 | +0.43 | +0.45 |
| T3 | +0.49 | +0.55 |
| T6 | −0.08 | +0.02 |
| T9 | +2.67 | +2.71 |
| T12 | +/−0 | +/−0 |

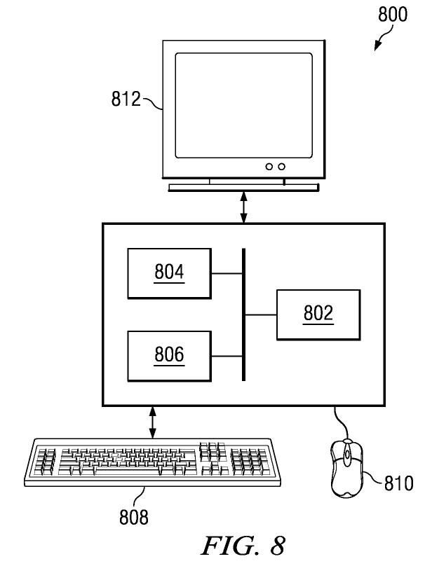

Embodiments of the methods and systems for motion estimation described herein may be implemented for virtually any type of digital system (e.g., a desk top computer, a laptop computer, a handheld device such as a mobile (i.e., cellular) phone, a personal digital assistant, a digital camera, etc.) with functionality to capture digital video images. For example, as shown in FIG. 8, a digital system (800) includes a processor (802), associated memory (804), a storage device (806), and numerous other elements and functionalities typical of today's digital systems (not shown). In one or more embodiments of the invention, a digital system may include multiple processors and/or one or more of the processors may be digital signal processors. The digital system (800) may also include input means, such as a keyboard (808) and a mouse (810) (or other cursor control device), and output means, such as a monitor (812) (or other display device). The digital system ((800)) may also include an image capture device (not shown) that includes circuitry (e.g., optics, a sensor, readout electronics) for capturing digital images. The digital system (800) may be connected to a network (814) (e.g., a local area network (LAN), a wide area network (WAN) such as the Internet, a cellular network, any other similar type of network and/or any combination thereof) via a network interface connection (not shown). Those skilled in the art will appreciate that these input and output means may take other forms.

Further, those skilled in the art will appreciate that one or more elements of the aforementioned digital system (800) may be located at a remote location and connected to the other elements over a network. Further, embodiments of the invention may be implemented on a distributed system having a plurality of nodes, where each portion of the system and software instructions may be located on a different node within the distributed system. In one embodiment of the invention, the node may be a digital system. Alternatively, the node may be a processor with associated physical memory. The node may alternatively be a processor with shared memory and/or resources.

Software instructions to perform embodiments of the invention may be stored on a computer readable medium such as a compact disc (CD), a diskette, a tape, a file, or any other computer readable storage device. The software instructions may be distributed to the digital system (800) via removable memory (e.g., floppy disk, optical disk, flash memory, USB key), via a transmission path (e.g., applet code, a browser plug-in, a downloadable standalone program, a dynamically-linked processing library, a statically-linked library, a shared library, compilable source code), etc.

While the invention has been described with respect to a limited number of embodiments, those skilled in the art, having benefit of this disclosure, will appreciate that other embodiments can be devised which do not depart from the scope of the invention as disclosed herein. For example, encoding architectures for compression standards other than H.264 may be used in embodiments of the invention and one of ordinary skill in the art will understand that these architectures may use the motion estimation methods described herein. Accordingly, the scope of the invention should be limited only by the attached claims.

It is therefore contemplated that the appended claims will cover any such modifications of the embodiments as fall within the true scope and spirit of the invention.

What is claimed is:

1. A method of motion vector estimation for video encoding comprising:
estimating a global motion vector for a sequence of macroblocks in a frame; and
estimating a motion vector for each macroblock in the sequence of macroblocks using the global motion vector to offset reference data for each macroblock.

2. The method of claim 1, wherein the sequence of macroblocks is a row of macroblocks in the frame.

3. The method of claim 1, wherein the sequence of macroblocks includes all macroblocks in the frame.

4. The method of claim 1, wherein estimating a global motion vector further comprises estimating the global motion vector using motion vectors of a sequence of macroblocks in a previous frame corresponding to the sequence of macroblocks.

5. The method of claim 4, wherein estimating a global motion vector further comprises averaging the motion vectors of the sequence of macroblocks in the previous frame.

6. The method of claim 4, wherein the previous frame is an inter-predicted frame.

7. The method of claim 1, wherein estimating a global motion vector further comprises estimating the global motion vector using global motion vectors for the sequence of macroblocks determined during video stabilization of the sequence of macroblocks.

8. The method of claim 7, wherein estimating a global motion vector further comprises averaging the global motion vectors for the sequence of macroblocks.

9. The method of claim 8, wherein estimating a global motion vector further comprises reducing the average of the global motion vectors by a crop area offset.

10. The method of claim 7, wherein estimating a global motion vector further comprises determining a global motion vector for each section of a plurality of rectangular sections of the frame, wherein a section comprises contiguous macroblocks.

11. A video encoder for encoding video frames, wherein encoding a video frame comprises:
estimating a motion vector for each macroblock in a sequence of macroblocks in the video frame using an estimated global motion vector to offset reference data for each macroblock.

12. The video encoder of claim 1, wherein the sequence of macroblocks is one selected from a group consisting of a row of macroblocks in the video frame and all macroblocks in the video frame.

13. The video encoder of claim 11, wherein the estimated global motion vector is determined using motion vectors of a sequence of macroblocks in a previous video frame corresponding to the sequence of macroblocks.

14. The video encoder of claim 13, wherein the previous video frame is an inter-predicted frame.

15. The video encoder of claim 11, wherein the estimated global motion vector is determined using global motion vectors for the sequence of macroblocks estimated during video stabilization of the sequence of macroblocks.

16. A digital system comprising:
a video front end configured to receive raw video data and convert the raw video data to video frames;
a memory configured to store the video frames; and
a video encoder configured to encode a video frame of the video frames by estimating a motion vector for each macroblock in the sequence of macroblocks using an estimated global motion vector to offset reference data for each macroblock.

17. The digital system of claim 16, wherein the sequence of macroblocks is one selected from a group consisting of a row of macroblocks in the video frame and all macroblocks in the video frame.

18. The digital system of claim 16, wherein the estimated global motion vector is determined using motion vectors of a sequence of macroblocks in a previous video frame corresponding to the sequence of macroblocks.

19. The digital system of claim 16, further comprising:
a video stablilizer configured to determine the estimated global motion vector.

20. The digital system of claim 19, wherein the video stabilizer is further configured to determine the estimated global motion vector using global motion vectors estimated for the sequence of macroblocks.
